(19) United States
(12) Patent Application Publication
(10) Pub. No.: US 2016/0268071 A1
(43) Pub. Date: Sep. 15, 2016

(54) WALL PLATE ASSEMBLIES FOR IDENTIFYING ELECTRICAL DEVICES

(71) Applicant: HUBBELL INCORPORATED, Shelton, CT (US)

(72) Inventors: Jason Thomas, Mesa, AZ (US); Jeff Hlade, South Bend, IN (US)

(73) Assignee: HUBBELL INCORPORATED, Shelton, CT (US)

(21) Appl. No.: 15/060,256

(22) Filed: Mar. 3, 2016

Related U.S. Application Data
(60) Provisional application No. 62/130,665, filed on Mar. 10, 2015.

(51) Int. Cl. H01H 9/18; G09F 13/04; G09F 3/20; G09F 3/02

(52) U.S. Cl. CPC H01H 9/182; G09F 3/02; G09F 13/04; G09F 3/20

(57) ABSTRACT

A wall plate assembly for identifying an electrical device includes a mounting plate having a first side and a second side with a first mounting opening defined therethrough. The first mounting opening is configured to secure the second side of the mounting plate to a wall. The mounting plate further includes a recess defined in the first side around the first mounting opening for receiving a labeling insert having first indicia that identifies a type of the electrical device. The labeling insert further includes a retention feature removably securing the labeling insert to the mounting plate in the recess where the first indicia is visible to a user from the first side of the mounting plate.

### CROSS REFERENCE TO RELATED APPLICATIONS

This application claims the benefit of U.S. Provisional Application No. 62/130,665 filed on Mar. 10, 2015, the entire contents of which are incorporated herein by reference.

### BACKGROUND OF THE INVENTION

1. Field of the Disclosure

The present disclosure is related to wall plate assemblies. More particularly, the present disclosure is related to wall plate assemblies for identifying electrical devices.

2. Description of Related Art

Wall plates are used to cover various electrical devices such as, but not limited to, light switches, dimmer switches, electrical outlets, and other electrical connection making devices. The electrical connection making devices can include telephone connections, fiber optic connections, internet connections, network connections, and others.

In some instances, the electrical device can be mounted to a wall having a junction box cut into the wall. In most cases, the interface of the wall and the junction box is rough in nature and requires the use of a wall plate. The wall plate provides a decorative transition of the electrical device to the wall. The wall plate also enhances safety as the elements of the electrical device are covered.

Although the prior art wall plates do possess some benefits, they are limiting in mitigating the unintentional actuation or use of the various electrical devices—particularly in instances where the intended functions of the electrical device is not readily apparent to the user. For example when a single wall plate is used to cover two electrical switches, the user is often left to guess as to which device the switches control.

Therefore, it has been determined by the present disclosure that there is a need for wall plate assemblies that overcome, alleviate, and/or mitigate one or more of the aforementioned and other deleterious effects of the prior art.

### SUMMARY

In some embodiments alone or in combination with any of the aft mentioned embodiments, a wall plate assembly for identifying an electrical device includes a mounting plate having a first side and a second side a first mounting opening defined therethrough. The first mounting opening is configured to secure the second side of the mounting plate to a wall.

In some embodiments alone or in combination with any of the aft mentioned embodiments, the mounting plate further includes a recess defined in the first side around the first mounting opening for receiving a labeling insert having first indicia that identifies a type of the electrical device.

In some embodiments alone or in combination with any of the aft mentioned embodiments, the mounting plate includes a window. The first mounting opening securing the second side of the mounting plate to the wall with a portion of the electrical device extending through the window for access by a user.

In some embodiments alone or in combination with any of the aft mentioned embodiments, the labeling insert further includes a retention feature removably securing the labeling insert to the mounting plate in the recess with the first indicia visible to a user from the first side of the mounting plate.

In some embodiments alone or in combination with any of the aft mentioned embodiments, the retention feature is defined on the recess, on the insert, and any combination thereof.

In some embodiments alone or in combination with any of the aft mentioned embodiments, the labeling insert has a first face having the first indicia being co-planer to the first side of the mounting plate.

In some embodiments alone or in combination with any of the aft mentioned embodiments, the labeling insert has a second face having a recess aligned with the mounting opening where the recess is sufficient to receive a portion of a mechanical fastener.

In some embodiments alone or in combination with any of the aft mentioned embodiments, the labeling insert has a second face having second indicia that identifies a different type of the electrical device.

In some embodiments alone or in combination with any of the aft mentioned embodiments, the retention feature removably secures the labeling insert to the mounting plate in the recess with either the first face or the second face of the insert in a common direction as the first side of the mounting plate so that the first indicia or the second indicia is visible to the user from the first side of the mounting plate.

In some embodiments alone or in combination with any of the aft mentioned embodiments, the first indicia is displayed on an addressable screen, the addressable screen being addressable to identify different types of electrical devices.

In some embodiments alone or in combination with any of the aft mentioned embodiments, the wall plate assembly includes a power source for the addressable screen.

In some embodiments alone or in combination with any of the aft mentioned embodiments, the power source is selected from the group consisting of a battery, a solar cell, a lead connectable to the electrical device, and any combinations thereof.

In some embodiments alone or in combination with any of the aft mentioned embodiments, the wall plate assembly further includes an addressing device for addressing the screen, the addressing device being selected from the group consisting of a wireless communication port, a dual in-line package (DIP) switch, and any combination thereof.

In some embodiments alone or in combination with any of the aft mentioned embodiments, the labeling insert has a first face visible from the first side of the mounting plate and a second face where the wall plate assembly further includes a light source configured to emit light towards the second face.

In some embodiments alone or in combination with any of the aft mentioned embodiments, the wall plate assembly further includes circuitry configured to emit light from the light source only when light conditions at the first side of the mounting plate are below a predetermined threshold.

In some embodiments alone or in combination with any of the aft mentioned embodiments, the first indicia is a removable label positioned between the second face of the labeling insert and the light source.

In some embodiments alone or in combination with any of the aft mentioned embodiments, the light emitted from the light source backlights the first indicia.

In some embodiments alone or in combination with any of the aft mentioned embodiments, the first indicia is selected from the group consisting of one or more graphical icons or symbols, one or more numeric indicia, one or more textual indicia, and any combinations thereof.

In some embodiments alone or in combination with any of the aft mentioned embodiments, the wall plate assembly further includes an orientation feature that only allows the labeling insert to be removably secured in the mounting plate in a desired orientation.

The above-described and other features and advantages of the present disclosure will be appreciated and understood by those skilled in the art from the following detailed description, and drawings.

### BRIEF DESCRIPTION OF THE DRAWINGS

FIG. 1 is an isometric view of an exemplary embodiment of a wall plate assembly according to the present disclosure having a labeling insert;

FIG. 2 is a detailed exploded view illustrating a labeling insert for use with the wall plate assembly of FIG. 1;

FIG. 3 is a rear isometric view of the labeling insert of FIG. 1;

FIG. 4 is a sectional view of the wall plate assembly of FIG. 1 taken along lines 4-4;

FIGS. 5-8 are isometric views of alternate exemplary embodiments of wall plates assembly according to the present disclosure having labeling inserts;

FIG. 9 is an isometric view of an exemplary embodiment of an addressable labeling insert according to the present disclosure for use with the wall plate assembly of FIG. 1; and

FIG. 10 is a top view of still another exemplary embodiment of an addressable wall plate assembly according to the present disclosure.

### DETAILED DESCRIPTION

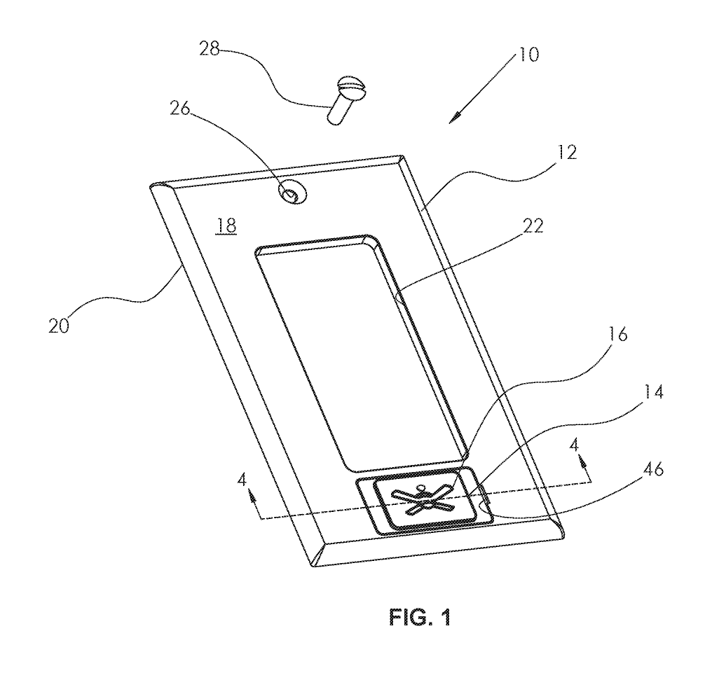

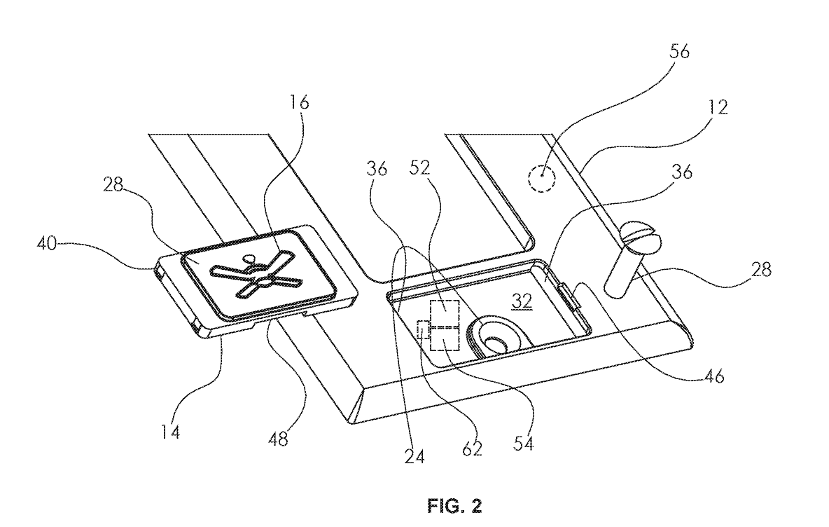

Referring to the drawings and in particular to FIGS. 1 and 2, a wall plate assembly according to an exemplary embodiment of the present disclosure is shown and is generally referred to by reference numeral 10. Assembly 10 includes a mounting plate 12 and a labeling insert 14, removably secured to the mounting plate. Labeling insert 14 advantageously includes indicia 16, which informs the user what electrical device the assembly 10 is associated with in a manner not previously possible.

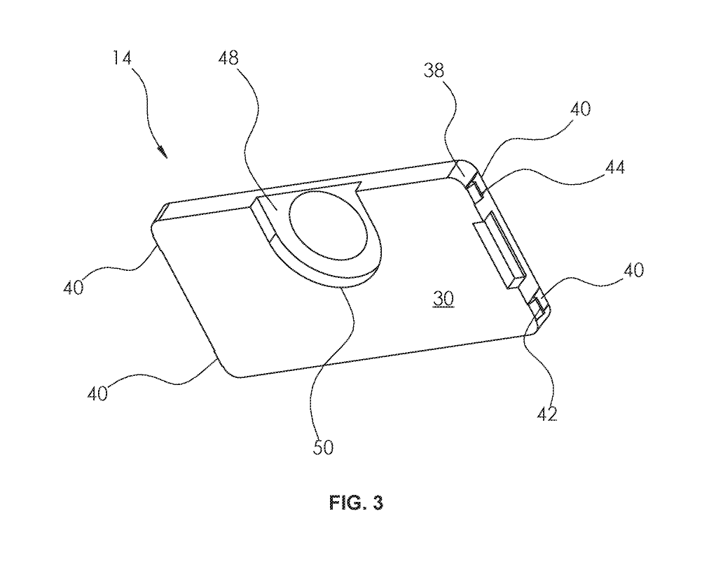

Assembly 10 is described in more detail with simultaneous reference to FIGS. 1-4.

Assembly 10, namely plate 12 and insert 14, can be fabricated of any material having sufficient strength and resiliency to provide the features and functions described herein. In some embodiments, plate 12 and insert 14 is molded thermoplastic material such as acrylonitrile butadiene styrene (ABS). Of course it is contemplated that plate 12 and/or insert 14 to be formed of alternate materials and/or methods of manufacture such as for example a sheet metal component fabricated by a stamping process.

Plate 12 has a first or front side 18 and a second or back side 20 and includes a device window 22, at least one mounting opening 24, and, in some embodiments, a second mounting opening 26 defined through the plate from the first side to the second side. In use, assembly 10 is secured to a wall (not shown) with second side 20 facing towards the wall and at least a portion of an electrical device (not shown) extending through or accessible via window 22. More specifically, assembly 10 is secured to the wall via first and second mounting openings 24, 26 and mechanical fasteners 28, which are illustrated as screws.

In the illustrated embodiment, window 22 is positioned and configured to receive an electrical device in the form of a rocker switch that controls a ceiling fan. Thus, indicia 16 is formed as a graphical icon or symbol in the shape of a ceiling fan. In this manner, the user can easily reference indicia 16 on assembly 10 to identify which device (i.e., the ceiling fan) is controlled by the electrical device (i.e., the rocker switch).

Indicia 16 is illustrated as being a protrusion that extends upward from insert 14. Of course it is contemplated by the present disclosure for indicia 16 to have any desired form such as, but not limited to, protrusions, indentations, printed indicia, and any combinations thereof. Moreover, indicia 16 are illustrated as being a single graphical icon or symbol. Of course it is contemplated by the present disclosure for indicia 16 to have any desired form such as, but not limited to, one or more graphical icons or symbols, one or more numeric indicia, one or more textual indicia, and any combinations thereof.

Insert 14 can be provided with indicia 16 in any desired manner such as, but not limited to, molding etching, printing, adhesive connection, stamping, and others.

It should be recognized that assembly 10 is described above by way of example only in use with an electrical device in the form of a rocker switch that controls a ceiling fan. Of course, assembly 10 can be configured—via positioning, shape, and size of window 22—for use with any desired electrical device such as, but not limited to, rocker switches, toggle switches, dimmer switches, electrical outlets, and other any electrical connection making devices including telephone connections, fiber optic connections, internet connections, network connections, and others. In embodiments where window 22 is configured for use with an electrical outlet, the window can include multiple openings for grounded (i.e., three prong) or ungrounded (i.e., two prong) plugs. Additionally, indicia 16 can be any desired indicia for identifying the controlled device such as, but not limited to, a ceiling fan, an outlet, a light, a garbage disposal, and any other device.

In some embodiments, first and second mounting openings 24, 26 are positioned so as to secure assembly 10 to a junction box in which the electrical device is secured. Alternately, first and second mounting openings 24, 26 are positioned so as to secure assembly 10 directly to the electrical device. In other embodiments, first and second mounting openings 24, 26 are positioned so as to secure assembly 10 directly to the wall. Of course, it is contemplated by the present disclosure for first and second mounting openings 24, 26 to have any desired positioned for securing assembly 10 directly or indirectly to the wall.

Insert 14 is illustrated having indicia 16 defined on only a first face 28. However, it is contemplated by the present disclosure for insert 14 to be reversible, namely to include different indicia 16 on both first face 28 and on second face 30. In this manner, the user can easily reverse insert 14 when assembly 10 is used with an electrical device that controls a different device.

Plate 12 further includes a recess 32 in first side 18, where the recess at least partially surrounds first mounting opening 24. Recess 32 is sized to removably receive insert 14 in a manner that covers first mounting opening 24. In this manner, assembly 10 is configured to make use of the space or surface area on first side 18 for indicia 16 that is normally reserved for first mounting opening 24. Additionally, insert 14 advantageously covers or obscures the mechanical fastener 28 positioned in first mounting opening 24 from view.

Assembly 10 includes one or more retention features configured to removably retain insert 14 in recess 32. The retention features can be on plate 12, insert 14, or a combination of the plate and insert. In some embodiments, the retention features are configured to removably secure insert 14 in recess 32 in a reversible manner—namely with either first face 28 or second face 30 of the insert facing outwards.

In some embodiments, assembly 10 is configured so that insert 14, when removably secured in recess 32, has first or second face 28, 30 that is flush or planar to first side 18 of plate 12. Of course, it is contemplated by the present disclosure for assembly 10 to be configured so that insert 14, when removably secured in recess 32, has first or second face 28, 30 that is recessed with respect to or extends above first side 18 of plate 12.

Assembly 10 is illustrated in the exemplary embodiment having retention the features on plate 12 and insert 14, where the insert is configured for use in a single orientation—namely with only first face 28 facing outwards.

Here, the retention features include one or more slots 36 located on recess 32 of plate 12, while insert 14 includes one or more locking tabs 40 in locations around the periphery of the insert that correspond to the location of the slots. Locking tabs 40 have a tapered or lead surface 42 and a retention surface 44.

During assembly, insert 14 is assembled into recess 32 of plate 12 so that retention surface 44 of locking tabs 40 are located in and retained by slots 36. Lead surfaces 42 in combination with the insertion force causes elastic deformation of plate 12, insert 14, or a combination of both, until retention surface 44 are located in and retained by slots 36, where the plate and/or insert return, under their own resiliency to the normal or un-deformed condition until selective removal is desired.

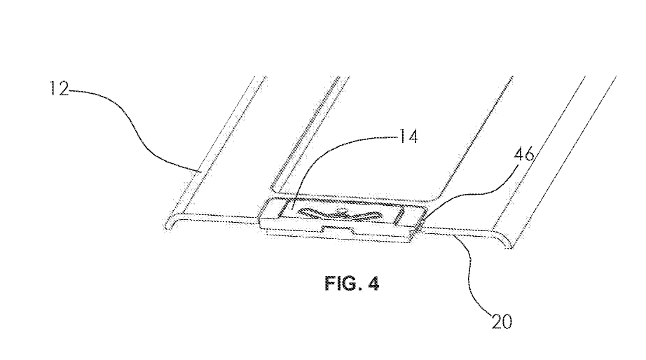

In some embodiments and as seen in FIG. 4, plate 12 and/or insert 14 can further includes a step 46 which facilitates the selective removal of the insert from the plate 12. Here, the user can insert a finger, coin, or tool into step 46 and pry insert 14 from recess 32. During removal, the removal force again causes elastically deformation of one or more of plate 12 and/or insert 14 until retention surface 44 are no longer located in and retained by slots 36, where the plate and/or insert return, under their own resiliency to the normal or un-deformed condition after removal.

In some embodiments, insert 14 can include a clearance slot 48 defined in second face 30. Slot 48 is configured to provide sufficient clearance to allow mechanical fastener 28 to be received in second face 30, which has been found to be useful at reducing the overall thickness of assembly 10.

In some embodiments, assembly 10 is configured so that insert 14 is only received in plate 12 in a single orientation. Here, plate 12 and/or insert 14 can include an orientation feature 50 that only allows the insert to be removably secured in the plate in a desired orientation. In other words, orientation feature 50 is configured so that insert 14 can be assembled in plate 12 in a single orientation such that the icon is readable by a user. If a user were to attempt to position insert 14 in plate 12 in an alternate orientation (i.e. inverted), orientation feature 50 would prevent such installation.

In the illustrated embodiment, clearance slot 48 also functions as orientation feature 50. Of course, it is contemplated by the present disclosure for plate 12 and/or insert 14 to have a separate orientation feature 50 or for other features—such as retention features (i.e. locking tabs 40/slots 36) to function as the orientation feature.

While indicia 16 have been described above with respect to assembly 10 as a physical feature, it is also contemplated by the present disclosure for the indicia to be a backlit indicia. Referring again to FIG. 2, here plate 12 is shown having one or more lighting sources 52 (only one shown) emitting light towards second face 30 of insert 14.

Light source 52 can be configured to emit light towards second face 30 by any desired method. For example, light source 52 can be positioned behind second or back side 20 of plate 12 and can emit the light through one or more openings (not shown) in the plate or can have sufficient intensity to transmit through the plate at least in the region of insert 14. For example, plate 12 can be formed from, at least in the region of insert 14, of a translucent or transparent material. Alternately, light source 52 can extend through plate 12 to first or front side 18 of the plate.

Lighting source 52 can be any desired light source such as, but not limited to a light emitting diode (LED), an incandescent light, and others. Additionally, light source 52 can be incorporated directly into plate 12 in the region of insert 14 or can include a light pipe or fiber optic fiber that transmits light emitted from the light source onto the region of the insert.

Assembly 10 can include a power source 54 for light source 52. Power source 54 can include one or more of a solar cell, a battery, an electrical lead from light source 52 to the electrical device in window 22, and any combinations thereof.

In this embodiment, light source 52 can have sufficient intensity to transmit through insert 14. For example, insert 14 can be formed from, at least in the region of indicia 16 or in regions surrounding the indicia, of a translucent or transparent material. Alternately or in addition, indicia 16 can be formed from a plurality of openings (not shown) extending from first face 28 to second face 30. The plurality of openings can define graphical icons or symbols, one or more numeric indicia, one or more textual indicia, and any combinations thereof.

It should be recognized that insert 14 is described in the backlighted embodiment as having indicia 16 on first face 28. However, it is contemplated by the present disclosure for indicia 16 to be on second face 30 so that it is only visible as a result of light emitted from light source 52. Also, it is contemplated for indicia 16 in the backlighted embodiment to be formed on a separate label (not shown) placed between second face 30 and light source 52.

Assembly 10 can be configured to emit light from light source 52 at all times, or in other embodiments, to only emit light from the light source, when light conditions at first side 18 of plate 12 are below a predetermined threshold as determined by the solar cell or other light sensor 56 on the plate. Here, assembly 10 includes solid state and/or integrated chip circuitry 62 sufficient to control light source 52, power source 54, and sensor 56 to operate as desired.

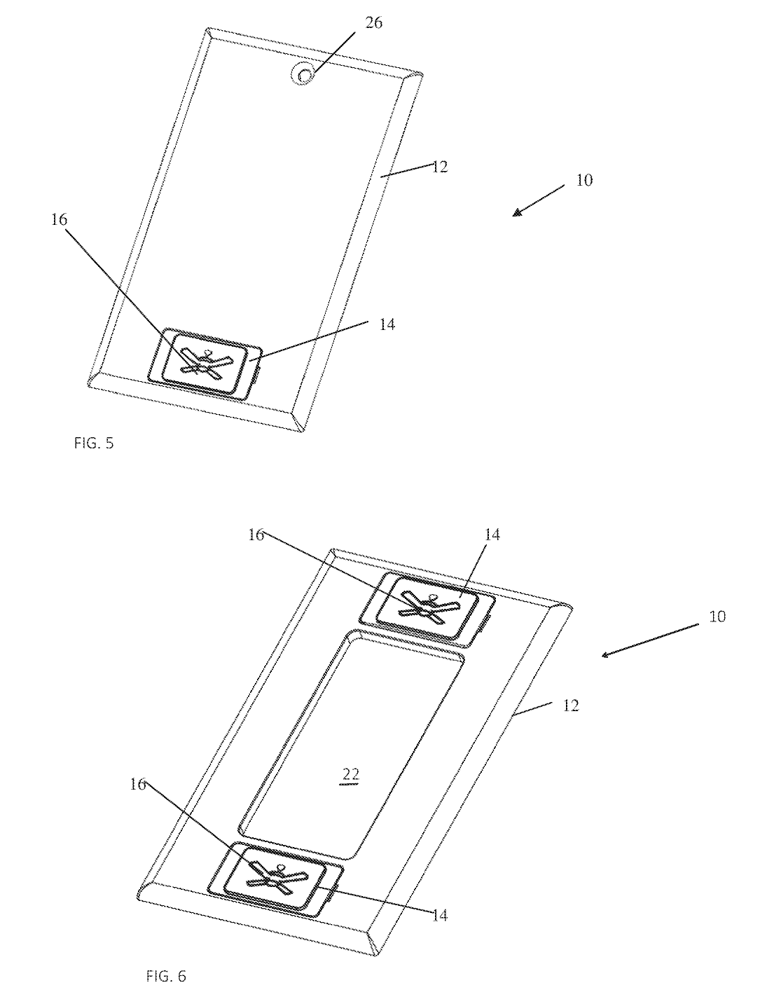

Referring now to FIG. 5, assembly 10 is illustrated having plate 12 that lacks the window of the embodiments of FIGS. 1-4 to allow the assembly to cover over a particular electrical device.

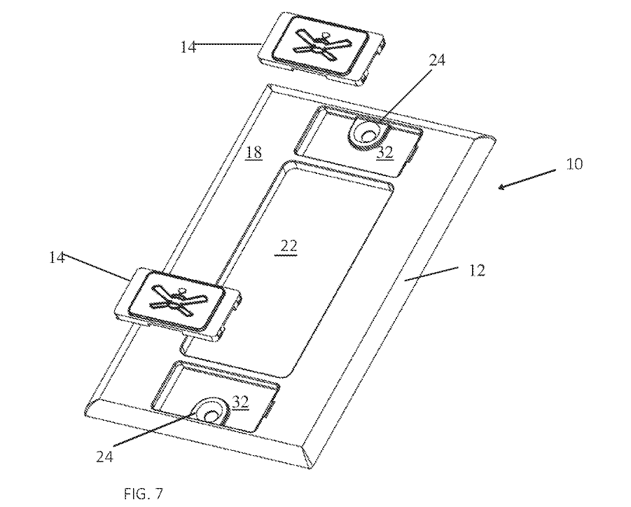

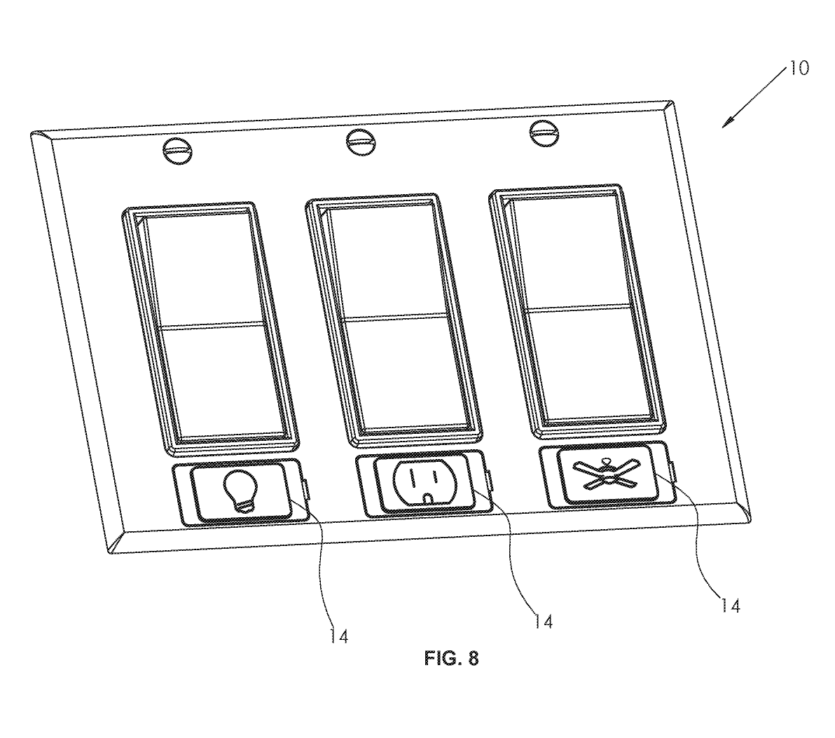

Assembly 10 is illustrated in FIGS. 6-7 having plate 12 with two inserts 14 for a single window 22, two recesses 32 in first side 18, where the recesses at least partially surround the two first mounting openings 24, respectively. As in the prior embodiments, recesses 32 are sized to removably receive inserts 14 in a manner that covers both of the first mounting openings 24.

Assembly 10 is illustrated in FIG. 8 having plate 12 with three windows 22, each having one removably received insert 14. In this manner, assembly 10 is configured to be used with three electrical devices. Of course, it is contemplated by the present disclosure for assembly 10 to be configured for use with any desired number of electrical devices—with our without window 22.

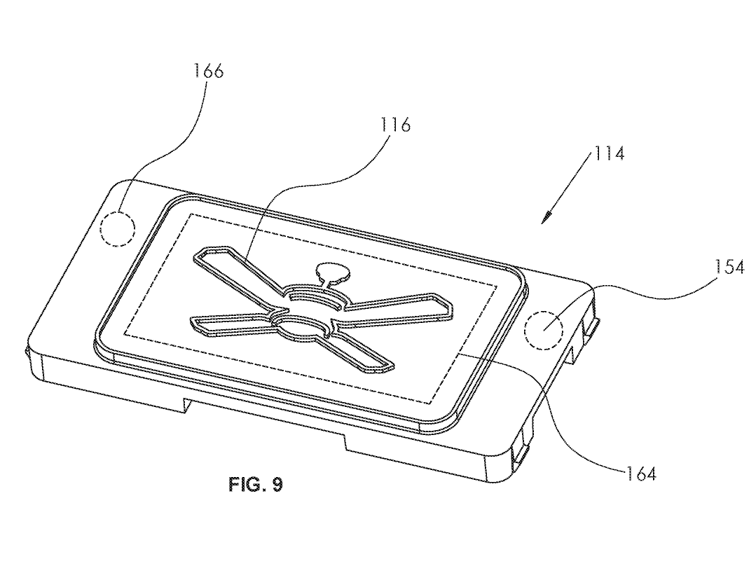

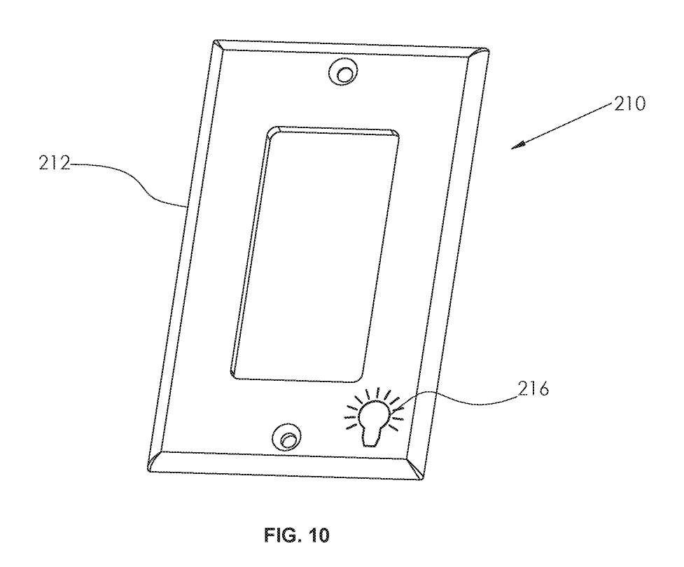

Referring now to FIG. 9, an exemplary embodiment of an addressable insert for use with the assembly of FIG. 1 is shown. Here, the addressable insert is referred to by reference numeral 114 with component parts performing similar and/or analogous functions being labeled in multiples of one hundred.

Insert 114 includes indicia 116, which in this example, is displayed on a display screen 164. Screen 164 can be powered by power source 154 in the manner discussed above. Preferably, screen 164 is addressable or programmable to display the desired indicia 116. For example, insert 114 can include a programming device 166 such as, but not limited to, a wired communication port, a wireless communication port, a dual in-line package (DIP) switch, and others. Here, the user can communicate with device 166 to program screen 164 to display the desired indicia 116.

Referring now to FIG. 10, a wall plate assembly according to another exemplary embodiment of the present disclosure is shown. Here, the assembly is referred to by reference numeral 210 with component parts performing similar and/or analogous functions being labeled in multiples of two hundred.

Assembly 210 includes indicia 216 provided without the need for any visible insert 14, 114. Rather, assembly 210 provides indicia 216 in the form of a light source (not shown) behind plate 212 that backlights the plate in a desired region to provide and/or enhances the visibility of the indicia. Here, plate 212 includes indicia 216 on the plate such that, upon illumination from the light source, the indicia are visible from first or front side 218 of the plate.

In some embodiments, indicia 216 are provided on first or front side 218 of plate and are visible without illumination by the light source. In other embodiments, indicia 216 are on the second or rear side of plate and are only visible with illumination by the light source. Also, it is contemplated for indicia 216 in the backlighted embodiment to be formed on a separate label (not shown) placed between the second or rear side of the plate and the light source. It is also contemplated for the second or rear side of the plate to have multiple different indicia provided in different locations, with the light source being selectively positionable with respect to the rear side so as to backlight on the desired indicia.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. In addition combinations of the different features can be combined to create different products. Therefore, it is intended that the present disclosure not be limited to the particular embodiment(s) disclosed as the best mode contemplated, but that the disclosure will include all embodiments falling within the scope of the present disclosure.

What is claimed is:

1. A wall plate assembly for identifying an electrical device, comprising:
a mounting plate having a first side and a second side and a first mounting opening defined therethrough, the first mounting opening being configured to secure the second side of the mounting plate to a wall, the mounting plate further including a recess defined in the first side around the first mounting opening;
a labeling insert having first indicia that identifies a type of the electrical device; and
a retention feature removably securing the labeling insert to the mounting plate in the recess with the first indicia visible to a user from the first side of the mounting plate.

2. The wall plate assembly of claim 1, further comprising a window defined through the mounting plate, the first mounting opening being configured to secure the second side of the mounting plate to the wall with a portion of the electrical device extending through the window for access by a user.

3. The wall plate assembly of claim 1, wherein the retention feature is defined on the recess, on the insert, and any combination thereof.

4. The wall plate assembly of claim 1, wherein the labeling insert has a first face having the first indicia, the first face of the labeling insert being co-planer to the first side of the mounting plate.

5. The wall plate assembly of claim 4, wherein the labeling insert has a second face, the second face having a recess aligned with the mounting opening, the recess being sufficient to receive a portion of a mechanical fastener.

6. The wall plate assembly of claim 4, wherein the labeling insert has a second face having second indicia that identifies a different type of the electrical device.

7. The wall plate assembly of claim 4, wherein the retention feature removably secures the labeling insert to the mounting plate in the recess with either the first face or the second face of the insert in a common direction as the first side of the mounting plate so that the first indicia or the second indicia is visible to the user from the first side of the mounting plate.

8. The wall plate assembly of claim 1, wherein the first indicia is displayed on an addressable screen, the addressable screen being addressable to identify a plurality of different types of the electrical device.

9. The wall plate assembly of claim 8, further comprising a power source for the addressable screen.

10. The wall plate assembly of claim 9, wherein the power source is selected from the group consisting of a battery, a solar cell, a lead connectable to the electrical device, and any combinations thereof.

11. The wall plate assembly of claim 8, further comprising an addressing device for addressing the screen, the addressing device being selected from the group consisting of a wired communication port, a wireless communication port, a dual in-line package (DIP) switch, and any combination thereof.

12. The wall plate assembly of claim 1, wherein the labeling insert has a first face visible from the first side of the mounting plate and a second face, the wall plate assembly further comprising a light source configured to emit light towards the second face.

13. The wall plate assembly of claim 12, further comprising circuitry configured to emit light from the light source only when light conditions at the first side of the mounting plate are below a predetermined threshold.

14. The wall plate assembly of claim 12, wherein the first indicia is a removable label positioned between the second face of the labeling insert and the light source.

15. The wall plate assembly of claim 12, wherein the light emitted from the light source backlights the first indicia.

16. The wall plate assembly of claim 1, wherein the first indicia is selected from the group consisting of one or more graphical icons or symbols, one or more numeric indicia, one or more textual indicia, and any combinations thereof.

17. The wall plate assembly of claim 1, further comprising an orientation feature that only allows the labeling insert to be removably secured in the mounting plate in a desired orientation.

18. A wall plate assembly for identifying an electrical device, comprising:
a mounting plate having a first side and a second side and a first mounting opening defined therethrough, the first mounting opening being configured to secure the second side of the mounting plate to a wall;
first indicia that identifies a type of the electrical device; and
a light source configured to emit light at the first indicia so that the first indicia is visible at the first side of the mounting plate.

19. The wall plate assembly of claim 18, wherein the first indicia is positioned between the second side of the mounting plate and the light source.

20. The wall plate assembly of claim 18, wherein the second side of the mounting plate comprises a plurality of different first indicia, the light source being selectively positionable with respect to the second side so as to backlight a selective one of the plurality of different first indicia.
